(19) United States
(12) Patent Application Publication
(10) Pub. No.: US 2020/0151458 A1
(43) Pub. Date: May 14, 2020

(54) APPARATUS AND METHOD FOR VIDEO DATA AUGMENTATION

(71) Applicant: Electronics and Telecommunications Research Institute, Daejeon (KR)

(72) Inventors: Jeong Woo SON, Daejeon (KR); Sang Hoon LEE, Seoul (KR); Alex LEE, Daejeon (KR); Sun Joong KIM, Sejong-si (KR)

(73) Assignee: Electronics and Telecommunications Research Institute, Daejeon (KR)

(21) Appl. No.: 16/683,227

(22) Filed: Nov. 13, 2019

(30) Foreign Application Priority Data
Nov. 13, 2018 (KR) 10-2018-0139324

(51) Int. Cl. G06K 9/00; G06N 3/08; G06F 16/783; G06F 16/78; G06F 16/75; G06F 16/787

(52) U.S. Cl. CPC G06K 9/00744; G06N 3/08; G06F 16/783; G06F 16/787; G06F 16/75; G06K 9/00765; G06F 16/7867

(57) ABSTRACT

A method and apparatus for video data augmentation that automatically constructs a large amount of learning data using video data. An apparatus for augmenting video data according to an embodiment of this disclosure, the apparatus including: a feature information check unit checking feature information including a content feature, a flow feature, and a class feature of a sub video of a predetermined unit constituting an original video; a section check unit selecting a video section including at least one sub video on the basis of the feature information of the sub video; and a video augmentation unit extracting at least one substitute sub video corresponding to the selected video section from multiple pre-stored sub videos, and applying the extracted at least one sub video to the selected video section to generate an augmented video.

### CROSS REFERENCE TO RELATED APPLICATION

The present application claims priority to Korean Patent Application No. 10-2018-0139324, filed Nov. 13, 2018, the entire content of which is incorporated herein for all purposes by this reference.

### BACKGROUND OF THE INVENTION

### Field of the Invention

The present disclosure relates to machine learning techniques and, more particularly, to an apparatus and method for data augmentation data sets used in machine learning.

### Description of the Related Art

Recently, machine learning and deep learning technologies that implement artificial intelligence based on learning data have been used in various fields.

Although the performance of AI learning models based on machine learning has improved dramatically with the advent of deep learning technology, it is still a large learning data set that determines the performance of learning models.

In particular, since video data is made up of a large amount of data, operations such as shooting and editing are required, and the collection environment is restricted, there is a problem that it is difficult to freely use the video data as learning data.

### SUMMARY OF THE INVENTION

Accordingly, the present disclosure has been made keeping in mind the above problems occurring in the prior art, and an objective of the present invention is to provide an apparatus and method for video data augmentation that automatically constructs a large amount of learning data using video data.

Another technical problem of the present disclosure is to provide an apparatus and method for video data augmentation that automatically generates video data according to a class to which a label of original video data belongs, and then constructs learning data used for machine learning.

Technical problems to be achieved in the present disclosure are not limited to the above-mentioned technical problems, and other technical problems not mentioned above will be clearly understood by those skilled in the art from the following description.

According to an embodiment of this disclosure, an apparatus for video data augmentation may be provided. The apparatus includes a feature information check unit checking feature information including a content feature, a flow feature, and a class feature for a sub video of a predetermined unit constituting an original video; a section check unit selecting a video section including at least one sub video on the basis of the feature information for the sub video; and a video augmentation unit extracting at least one substitute sub video corresponding to the selected video section from multiple pre-stored sub videos, and applying the extracted at least one sub video to the selected video section to generate an augmented video.

The features briefly summarized above with respect to the present disclosure are merely exemplary aspects of the detailed description of the present disclosure described below, and do not limit the scope of the present disclosure.

According to the present disclosure, a method and apparatus for video data augmentation that automatically constructs a large amount of learning data using video data can be provided.

According to the present disclosure, it is possible to provide an apparatus and method for video data augmentation that automatically generates video data according to a class to which a label of original video data belongs, and then constructs learning data used for machine learning.

According to the present disclosure, since a large amount of video data can be automatically generated with only a small amount of original video data, it is possible to reduce the construction cost of the learning data and further improve the performance of the learning model as learning is performed using a large amount of video data.

Effects obtained in the present disclosure are not limited to the above-mentioned effects, and other effects not mentioned above may be clearly understood by those skilled in the art from the following description.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a diagram illustrating a hierarchical structure of a video used in an apparatus for video data augmentation according to an embodiment of the present disclosure.

FIG. 2 is a block diagram illustrating a configuration of an apparatus for video data augmentation according to an embodiment of the present disclosure.

FIG. 3 is a view of an example showing information of the original data and information about the section inserted into the augmented video according to an embodiment of the present disclosure

FIG. 4 is a drawing illustrating a detailed operation of a feature information check unit included in an apparatus for video data augmentation according to an embodiment of the present disclosure.

FIG. 5 is a diagram illustrating a detailed operation of a video augmentation unit provided in an apparatus for video data augmentation according to an embodiment of the present disclosure.

FIG. 6 is a flowchart illustrating a procedure of a method for video data augmentation according to an embodiment of the present disclosure.

FIG. 7 is a block diagram illustrating a computing system that executes a method and apparatus for video data augmentation according to an embodiment of the present disclosure.

### DETAILED DESCRIPTION OF THE INVENTION

Hereinbelow, exemplary embodiments of the present disclosure will be described in detail with reference to the accompanying drawings such that the present disclosure can be easily embodied by one of ordinary skill in the art to which this invention belongs. However, the present disclosure may be variously embodied, without being limited to the exemplary embodiments.

In the description of the present disclosure, the detailed descriptions of known constitutions or functions thereof may be omitted if they make the gist of the present disclosure unclear. Also, portions that are not related to the present disclosure are omitted in the drawings, and like reference numerals designate like elements.

In the present disclosure, when an element is referred to as being “coupled to”, “combined with”, or “connected to” another element, it may be connected directly to, combined directly with, or coupled directly to another element or be connected to, combined directly with, or coupled to another element, having the other element intervening therebetween. Also, it should be understood that when a component “includes” or “has” an element, unless there is another opposite description thereto, the component does not exclude another element but may further include the other element.

In the present disclosure, the terms “first”, “second”, etc. are only used to distinguish one element, from another element. Unless specifically stated otherwise, the terms “first”, “second”, etc. do not denote an order or importance. Therefore, a first element of an embodiment could be termed a second element of another embodiment without departing from the scope of the present disclosure. Similarly, a second element of an embodiment could also be termed a first element of another embodiment.

In the present disclosure, components that are distinguished from each other to clearly describe each feature do not necessarily denote that the components are separated. That is, a plurality of components may be integrated into one hardware or software unit, or one component may be distributed into a plurality of hardware or software units. Accordingly, even if not mentioned, the integrated or distributed embodiments are included in the scope of the present disclosure.

In the present disclosure, components described in various embodiments do not denote essential components, and some of the components may be optional. Accordingly, an embodiment that includes a subset of components described in another embodiment is included in the scope of the present disclosure. Also, an embodiment that includes the components described in the various embodiments and additional other components are included in the scope of the present disclosure.

Hereinafter, embodiments of the present disclosure will be described with reference to the accompanying drawings.

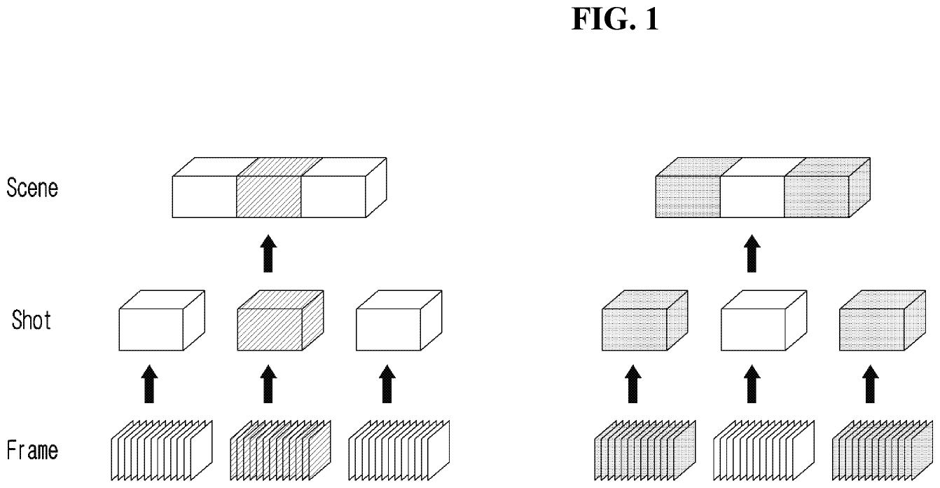

FIG. 1 is a diagram illustrating a hierarchical structure of a video used in an apparatus for video data augmentation according to an embodiment of the present disclosure.

Referring to FIG. 1, a hierarchical structure is shown in which similar frames are gathered to form a shot, a group of shots having a similar meaning forms a scene, and a set of scenes constitutes a video.

Hereinafter, the apparatus for video data augmentation according to an embodiment of the present disclosure extracts features of the video data on the basis of a predetermined unit, generates the video data on the basis of the predetermined unit, and performs learning on the generated video data.

Hereinafter, in describing the apparatus for video data augmentation according to an embodiment of the present disclosure, the predetermined unit described above will be exemplified as a unit of “shot”. Although an embodiment of the present disclosure is described on the basis of a unit of “shot”, the present disclosure is not limited thereto, and the predetermined unit may be changed to a unit of “frame” or “scene”.

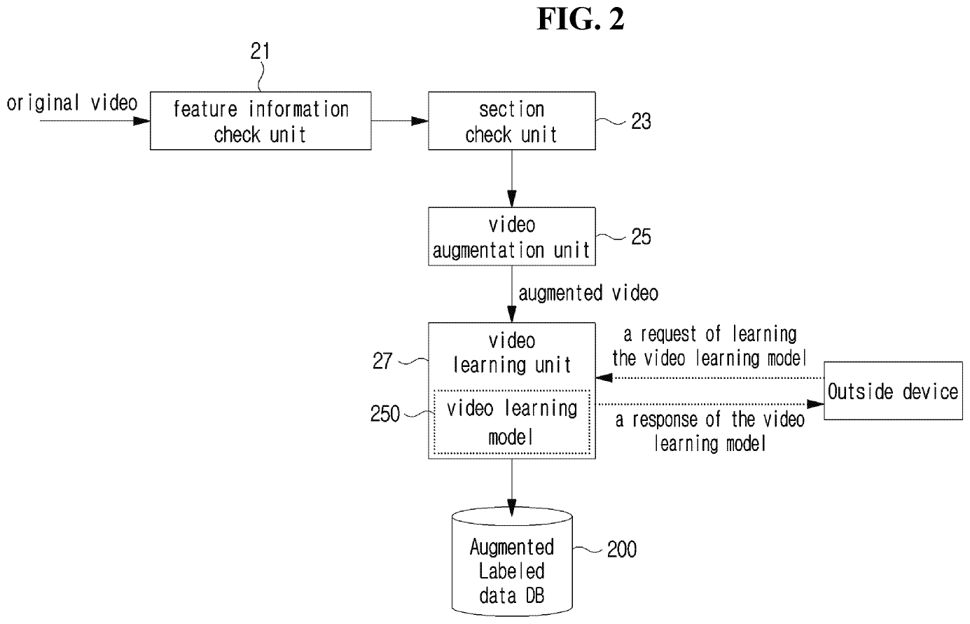

FIG. 2 is a block diagram illustrating a configuration of an apparatus for video data augmentation according to an embodiment of the present disclosure.

Referring to FIG. 2, the apparatus for video data augmentation according to an embodiment of the present disclosure may include a feature information check unit 21, a section check unit 23, and a video augmentation unit 25.

The feature information check unit 21 may check feature information including a content feature, a flow feature, and a class feature of a sub video of a predetermined unit constituting the original video.

Here, the content feature vc may be a feature of content included in a unit of sub video, and the flow feature vm may be a feature representing a difference between adjacent sub video units unlike the content feature vc. The class feature may be extracted on the basis of class information about a sub video unit together with the content feature vc and the flow feature vm that are extracted.

The section check unit 23 may select a video section including at least one sub video on the basis of the feature information of the sub video.

The apparatus for video data augmentation according to an embodiment of the present disclosure is to augment a video used for learning. The apparatus for video data augmentation may modify the original video to generate a new video. It is preferable to transform a part that is meaningful as learning data into a substitute section, thereby constructing an augmented video.

Therefore, when the original data is unconditionally deformed, a situation in which a specific type of video data is duplicated and then generated may occur. As such, when the specific type of video data is generated, the model may be biased when constructing the learning model using the specific type of video data, thereby causing a problem that the video data is not meaningful as the learning data. In consideration of this, the section check unit 23 may be configured to select a meaningful section as the learning data by reflecting the aforementioned feature information.

For example, the section check unit 23 may check a change amount of the at least one sub video on the basis of the class feature, and select the video section on the basis of the change amount. Furthermore, the section check unit 23 checks an average value and a deviation value for the content and flow features of the sub video, checks a probability value based on the average value and the deviation value, and selects the video section in consideration of the ratio between the probability value and the change amount.

In addition, the section check unit 23 checks a start point of the at least one sub video on the basis of a class feature, checks length information from the start point, and selects the video section on the basis of the start point and the length information.

Meanwhile, the video augmentation unit 25 extracts at least one substitute sub video corresponding to the selected video section from multiple pre-stored sub videos, and applies the extracted at least one sub video to the selected video section, thereby generating an augmented video.

For example, the video augmentation unit 25 may check feature information of the multiple pre-stored sub videos and feature information of a sub video adjacent to the selected video section. In consideration of the feature information of the multiple pre-stored sub videos and the feature information of the sub video adjacent to the selected video section, it is possible to extract at least one substitute sub video corresponding to the selected video section. The video augmentation unit 25 may insert the extracted at least one sub video into a corresponding section, thereby constructing an augmented video.

Furthermore, the apparatus for video data augmentation according to an embodiment of the present disclosure may further include a video learning unit 27.

The video learning unit 27 may receive an augmented video from the video augmentation unit 25, and may construct and store the augmented video as video learning data. Furthermore, the video learning unit 27 may store the augmented video in a DB 200 by discriminating the augmented video from the original video. For example, the video learning unit 27 may specify and store a class feature of a substitute sub video in an inserted section, among sub videos included in the augmented video.

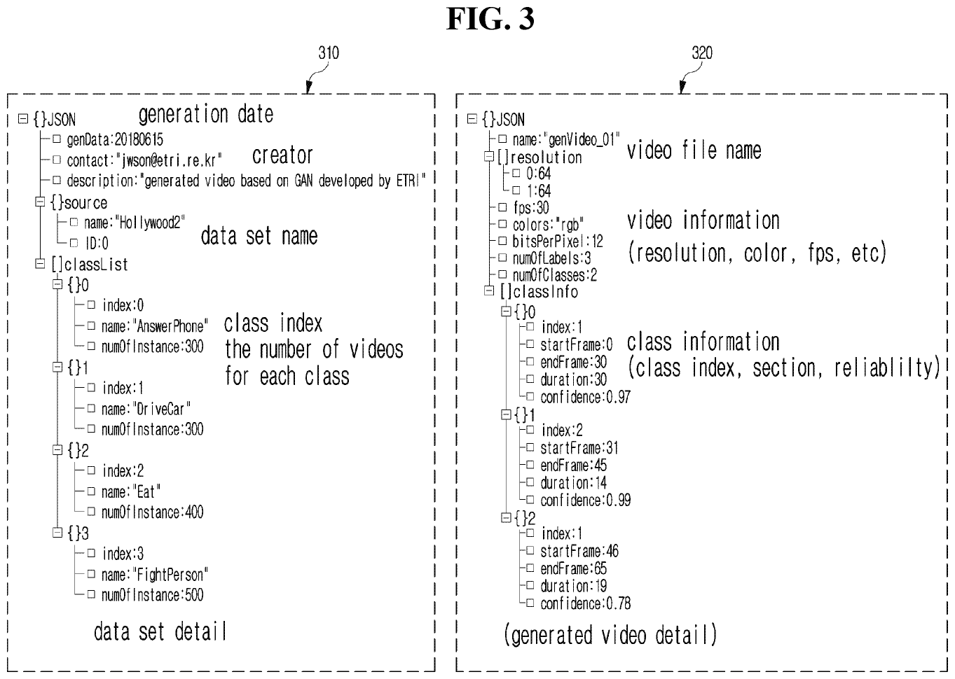

Specifically, the video learning unit 27 specifies information 310 (see FIG. 3) (e.g., generation date, creator, data set name, class index, the number of videos for each class, etc.) of the original data corresponding to the augmented video and information about the class distribution. In addition, the video learning unit 27 may specify information (class index, interval, reliability, etc.) 320 about the section inserted into the augmented video.

Furthermore, the video learning unit 27 may include a learning interface. The learning interface may receive a request of learning a video learning model from at least one outside device and build the video learning model 250 by learning the original video and the augmented video. The learning interface may provide the video learning model 250 to the at least one outside device.

Hereinafter, the detailed operation of the components provided in the apparatus for video data augmentation according to an embodiment of the present disclosure will be described referring to the accompanying drawings.

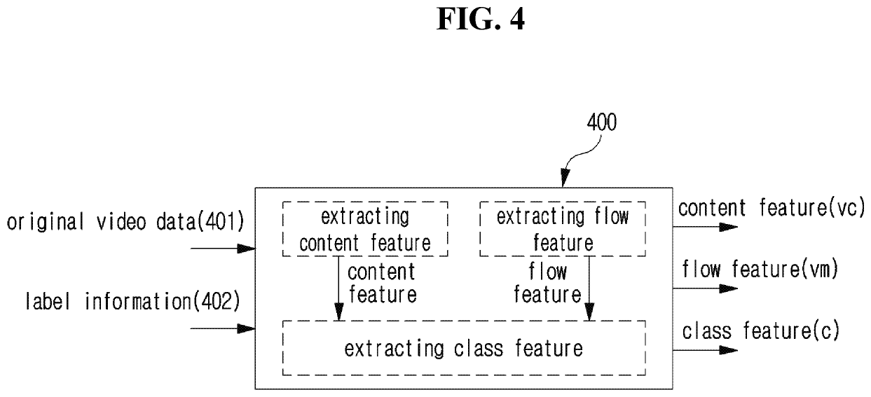

FIG. 4 is a drawing illustrating a detailed operation of a feature information check unit included in an apparatus for video data augmentation according to an embodiment of the present disclosure.

The feature information check unit 400 may receive the original video data 401 and the label information 402 related thereto, and extract a content feature, a flow feature, and a class feature on the basis of the input information 401 and 402.

First, the feature information check unit 400 may extract the content feature, in which the content feature vc may be derived through a function fc(V). fc is composed of linear functions of multiple stages which maps the video data to a low dimensional space using a parameter W. Herein, W is learned so that an optimal content feature may be extracted, based on whether the video data may be reproduced.

Initially, the parameter W is defined as a vector composed of random real values. Then, the values of W are adjusted so that the generated content features of all i-th shots constituting V may be estimated as accurately as possible. The estimated W* may be illustrated as Equation 1 below.

$$\text{?} = arg {min}_{W} \frac{1}{2} \text{?} {( {fc}^{- 1} ( fc ( V ) ) - {V}_{i} )}^{2} \\ \text{?} \text{indicates text missing or illegible when filed} \qquad [ Equation 1 ]$$

Where, fc⁻¹ is an inverse function of the function fc, which maps the content feature to the shot space, and Vᵢ is the i-th shot constituting V. Therefore, any shot generated on the basis of the content feature for the entire video data V is to force W to be similar to all shots constituting the original video.

The feature information check unit 400 may perform repetitive operations on a unit of shot included in the original video data to calculate an optimal W*.

The feature information check unit 400 may extract a flow feature vm, which may be extracted to reflect the difference between adjacent shots, unlike the content feature. That is, the feature information check unit 400 may extract a difference in video between the i-th shot and the i+1-th shot so that the flow feature may include the same. The feature information check unit 400 may calculate the flow feature through a function fm(V). fm (V) is a function that returns the flow feature expressing the difference between the shot units using the parameter Z. Herein, Z may be adjusted so that a shot similar to the i+1-th shot may be generated when the flow feature is added to the i-th shot information. The final learned z* may be illustrated as Equation 2 below.

$${Z}^{*} = arg {min}_{Z} \frac{1}{2} \text{?} ( ( {V}_{i} + {fm}^{- 1} ( fm ( V ) ) ) - V \text{?} ) \text{?} \\ \text{?} \text{indicates text missing or illegible when filed} \qquad [ Equation 2 ]$$

Where, fm−1 is an inverse function of the function fm.

The optimal Z* may be represented as a vector containing an average change between two shots, which may be generated as a flow feature.

The feature information check unit 400 may extract a class feature, and the class feature may be extracted on the basis of the extracted content and flow features and class information. The class feature (c) may be derived through a function g(V,C), and may be configured through a parameter P and linear functions of multiple stages based on the parameter P as in the above-described fc and fm.

Furthermore, when multiple classes are present, the vector representing the specific class should be configured to have information that is different from other classes, when reflecting the content feature and flow feature of the sub video constituting the target class. Therefore, g(V,C) refers to a linear combination of the content features and flow features extracted from any videos V1, V2, and V3 belonging to class C on the basis of the parameter P, and should be sufficiently distinguished from the class vector derived from other classes. Therefore, P is defined differently for each class, and the parameter PC for class C may be calculated through an operation of Equation 3 below.

$${P}_{O} = {argmax}_{{P}_{O}} \frac{1}{2} {( E \text{?} ( g ( V , C , {P}_{O} ) ) - E \text{?} ( g ( {V}^{′} , {C}^{- 1} ; {P}_{{O}^{- 1}} ) ) )}^{2} \\ \text{?} \text{indicates text missing or illegible when filed} \qquad [ Equation 3 ]$$

Where, c−1 means a class excluding C, and a function E is a function that takes an average.

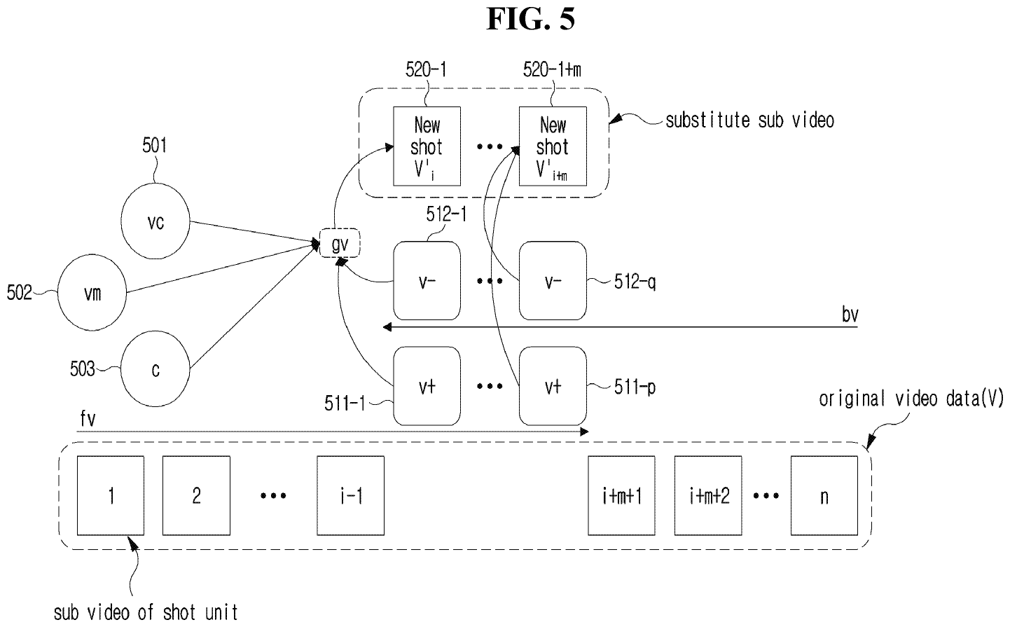

FIG. 5 is a diagram illustrating a detailed operation of a video augmentation unit provided in an apparatus for video data augmentation according to an embodiment of the present disclosure.

As described above, the video augmentation unit receives a content feature vc 501, a flow feature vm 502, a class feature c 503, and original video data V, selects a specific section within the data, and then replaces at least one sub video included in the selected section with a new substitute sub video, thereby augmenting the video.

Since the original video data V is composed of a plurality (n) of sub videos in units of shots, the starting point i and the length m of the section selected by the video augmentation unit may be defined as follows.

i<n and i+m<=n

The apparatus for video data augmentation according to an embodiment of the present disclosure is for automatically constructing video data that may be used as learning data.

When the original video data is unconditionally modified, video data of a specific type may be repeatedly generated. As such, when a learning model is constructed using the video data of a specific type, the learning model may be biased. Therefore, there is a problem that the video data repeatedly generated in a specific type cannot be used as learning data. To this end, the video augmentation unit needs to select a section that is meaningful as the learning data and replace the sub video of the corresponding section with a substitute sub video.

In view of the foregoing, it is possible to determine the deformation start point i and the length m. For example, the video augmentation unit may determine the deformation start point i through the calculation of Equation 4 below.

$${i}^{*} = arg {min}_{1 \leq i < n} \frac{{var}_{C} ( {V}_{i} )}{P ( {V}_{i} \text{\textbar} C )} \qquad [ Equation 4 ]$$

Where, var_{c} indicates a change amount of the i-th shot information in the class C. P(Vᵢ|C) indicates a probability that a shot similar to the i-th shot in the class C is derived.

The change amount may be determined on the basis of a result obtained by calculating the average and deviation based on the content feature and flow feature of all video data V belonging to the class. In addition, P(Vᵢ|C) may be a value representing a probability value based on the distance between the content feature and the flow feature extracted from Vᵢ and the class feature.

Meanwhile, the video augmentation unit calculates the scores for the sub videos of a shot unit located later on the basis of the deformation start point i, checks the average value of the scores and the score in the i-th shot, and determines the length m on the basis of the same. For example, the video augmentation unit may determine the length m through the calculation of Equation 5 below.

$$\text{?} = arg max \text{?} \text{?} ( \frac{{var}_{C} ( \text{?} )}{P ( {V}_{i} \text{\textbar} C )} - \frac{1}{m + 1} \text{?} \frac{{var}_{C} ( {V}_{j} )}{P ( {V}_{i} \text{\textbar} C )} ) ≦ t \\ \text{?} \text{indicates text missing or illegible when filed} \qquad [ Equation 5 ]$$

Although an embodiment of the present disclosure exemplifies determining the deformation start point i using Equation 4 described above, the present disclosure is not limited thereto. The method of determining of the deformation start point i may be variously changed. For example, the deformation start point i may be determined manually by the user's designation or may be determined using manually tagged information.

Similarly, although one embodiment of the present disclosure illustrates the determining of the length m using Equation 5 described above, the present disclosure is not limited thereto. The method of determining of the length m can be variously changed. For example, the deformation start point i may be determined manually by the user's designation, or may be determined using the manually designated information.

When the deformation start point i and the length m are determined, the video augmentation unit replaces the sub video included in the corresponding interval with the substitute sub video 520-1, . . . , and 520-1+m.

Specifically, the video augmentation unit may construct substitute sub videos 520-1, . . . , and 520-1+m) by using a first function (Equation 6) that generates vectors v+ 511-1, . . . , and 511-p containing information of the previous shot unit to the next shot unit and a second function (Equation 7) that generates vectors v− 512-1, . . . , and 512-q containing information of the next shot to the previous shot.

fv(V_{o→i-v}vc,vm,c) [Equation 6]

bv(V_{i+m→v}vc,vm,c) [Equation 7]

Where, V_{i->j} means sub videos from i to j in the video V.

The video augmentation unit may generate v+ 511-1, . . . , and 511-p and v− 512-1, . . . , and 512-q for the shot unit using the first and second functions, in which v+ 511-1, . . . , and 511-p and v− 512-1, . . . , and 512-q may be generated for shot units obtained by adding the length m to the deformation start point i starting from the shot of the deformation start point i. The generated v+ 511-1, . . . , and 511-p and v− 512-1, . . . , and 512-q may be used for calling a third function (Equation 8) 505 generating Vi that is a virtual i-th shot.

gv(v+,v−,vc,vm,c) [Equation 8]

Furthermore, the video augmentation unit may use the above-described third function 505 to configure the substitute sub videos 520-1, . . . , and 520-1+m corresponding to the shot unit obtained by adding the length m to the deformation start point i starting from the shot of the deformation start point i. The first, second, and third functions used in the construction of the substitute sub videos 520-1, . . . , and 520-1+m may be constructed by using recurrent neural networks (RNNs), long short-term memory models (LSTMs), generative adversarial networks (GANs), and the like.

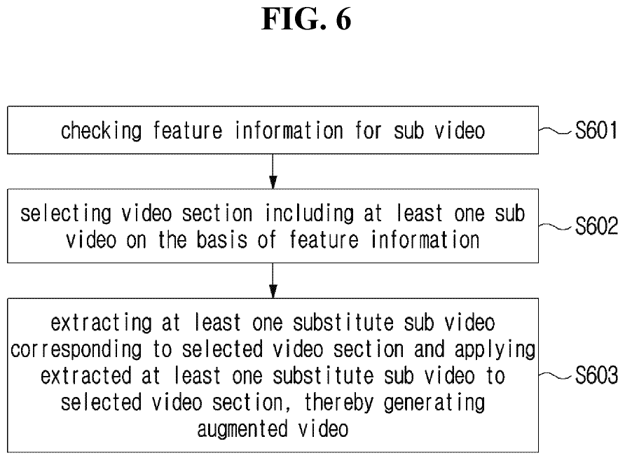

FIG. 6 is a flowchart illustrating a procedure of a video data augmentation method according to an embodiment of the present disclosure.

The video data augmentation method according to an embodiment of the present disclosure may be performed by the apparatus for video data augmentation according to the above-described embodiment.

In step S601, the apparatus for video data augmentation may identify feature information including a content feature, a flow feature, and a class feature of a sub video of a predetermined unit constituting the original video.

Here, the content feature vc may be a feature for contents included in the sub video unit, and the flow feature vm may be a feature representing a difference between adjacent sub video units unlike the content feature vc. The class feature may be extracted on the basis of class information about a sub video unit together with the extracted content feature vc and flow feature vm.

In detail, the apparatus for video data augmentation may extract content features, in which the content features vc may be derived through a function fc(V). fc is composed of linear functions of multiple stages which maps the video data to a low dimensional space using a parameter W. Herein, W is learned so that an optimal content feature may be extracted, based on whether the video data may be reproduced. Initially, W is defined as a vector composed of random real values. Then, the values of W are adjusted so that the generated content feature of all i-th shots constituting V may be estimated as accurately as possible. The estimated W* may be illustrated as Equation 1 below.

The apparatus for video data augmentation may calculate the optimal W* by repeatedly performing the shot unit included in the original video data.

In addition, the apparatus for video data augmentation may extract a flow feature vm, in which the flow feature may be extracted to reflect a difference between adjacent shots, unlike the content feature. That is, the apparatus for video data augmentation may extract the difference in videos between the i-th shot and the i+1-th shot so that the flow feature is included. The apparatus for video data augmentation may calculate the flow feature through a function fm(V). fm(V) is a function that returns a flow feature expressing a difference between shot units using a parameter Z. Herein, Z may be adjusted so that a shot similar to the i+1-th shot is generated when the flow feature is added to the i-th shot information. The final learned Z* may be illustrated as Equation 2 described above. The optimal Z* may be represented as a vector containing an average change between two shots, which may be generated as a flow feature.

Furthermore, the apparatus for video data augmentation may extract a class feature, in which the class extract feature may be extracted on the basis of the extracted content and flow features, and class information. The class feature c may be derived through the function g(V,C), and may be configured through a parameter P and linear functions in multiple stages based on the parameter P as in fc and fm described above.

Furthermore, when multiple classes are present, the vector representing the specific class should be configured to have information that is different from other classes, when reflecting the content feature and flow feature of the sub video constituting the target class. Therefore, g(V,C) refers to a linear combination of the content feature and flow feature extracted from any videos V1, V2, and V3 belonging to class C on the basis of the parameter P, and should be sufficiently distinguished from the class vector derived from other classes. Therefore, P is defined differently for each class, and a parameter P_{C} for class C may be calculated through an operation of Equation 3 disclosed above.

Meanwhile, in step S602, the apparatus for video data augmentation may select a video section including at least one sub video on the basis of the feature information of the sub video.

The apparatus for video data augmentation according to an embodiment of the present disclosure is used to variously augment a video used for learning. The apparatus for video data augmentation may generate a new video by deforming the original video. It is preferable to deform a part that is meaningful as learning data into a substitute section, thereby constructing the augmented video.

Therefore, when the original data is unconditionally deformed, a situation in which video data of a specific type is duplicated and then generated may occur. As such, when the video data of a specific type is generated, the model may be biased when constructing the learning model using the video data of a specific type, thereby causing a problem that the video data is not meaningful as the learning data. In consideration of this, the video data augmentation device may be configured to select a section that is meaningful as the learning data by reflecting the aforementioned feature information.

In detail, the apparatus for video data augmentation may select a video section as follows.

The video augmentation unit may receive a content feature vc 501, a flow feature vm 502, a class feature c 503, and an original video data V, and select a specific section within the data.

Since the original video data V is composed of a plurality (n) of sub videos in units of shots, the starting point i and the length m of the section selected by the video augmentation unit may be defined as follows.

i<n and i+m<=n

The apparatus for video data augmentation according to an embodiment of the present disclosure is for automatically constructing video data that may be used as learning data. When the original video data is unconditionally modified, video data of a specific type may be repeatedly generated. As such, when a learning model is constructed using the video data of a specific type, the learning model may be biased. Therefore, there is a problem that video data repeatedly generated in a specific form cannot be used as learning data. To this end, the video augmentation unit needs to select a section that is meaningful as the learning data and substitute the sub video of the corresponding section with a substitute sub video.

In view of the foregoing, it is possible to determine the deformation start point i and the length m. For example, the video augmentation unit may determine the deformation start point i through the calculation of Equation 4 disclosed above.

The change amount may be determined on the basis of a result obtained by calculating the average and deviation based on the content feature and flow feature of all video data V belonging to the class. In addition, P(Vᵢ|C) may be a value representing a probability value based on the distance between the content feature and flow feature extracted from Vᵢ and the class feature.

Meanwhile, the apparatus for video data augmentation calculates the scores for sub videos of a shot unit located later on the basis of the deformation start point i of the length m, checks an average value of the scores and the score in the i-th shot, and determines the length m on the bias of the same. For example, the video augmentation unit may determine the length m through the calculation of Equation 5 disclosed above.

Although an embodiment of the present disclosure illustrates the determination of the deformation start point i using Equation 4 described above, the present disclosure is not limited thereto. The method of determining of the deformation start point i may be variously changed. For example, the deformation start point i may be determined manually by the user's designation, or may be determined using manually tagged information.

Similarly, although one embodiment of the present disclosure illustrates the determination of the length m using Equation 5 described above, the present disclosure is not limited thereto. The method of determining of the length m may be variously changed. For example, the deformation start point i may be determined manually by the user's designation, or may be determined using the manually designated information.

In step S603, the apparatus for video data augmentation extracts at least one substitute sub video corresponding to the selected video section from multiple pre-stored sub videos, and applies the extracted at least one substitute sub video to the selected video section, thereby generating the augmented video.

For example, the apparatus for video data augmentation may check the feature information of the multiple pre-stored sub videos stored and the feature information of the sub video adjacent to the selected video section. In consideration of the feature information of the multiple pre-stored sub videos and the feature information of sub video adjacent to the selected video section, at least one substitute sub video corresponding to the selected video section may be extracted. The apparatus for video data augmentation may insert the extracted at least one sub video into the corresponding section, thereby constructing the augmented video.

Hereinafter, an example in which the apparatus for video data augmentation construct the augmented video using a substitute sub video will be described in detail.

The apparatus for video data augmentation may construct substitute sub videos 520-1, . . . , and 520-1+m) by using a first function (Equation 6) that generates vectors v+ 511-1, . . . , and 511-p containing information of the previous shot unit to the next shot unit and a second function (Equation 7) that generates vectors v− 512-1, . . . , and 512-q containing information of the next shot from the previous shot.

The apparatus for video data augmentation may generate v+ and v− for the shot unit using the first and second functions, and generate v+ 511-1, . . . , and 511-p and v− 512-1, and 512-q for shot units obtained by adding the length m to the deformation start point i starting from the shot of the deformation start point i. The generated v+ 511-1, . . . , and 511-p and v− 512-1, . . . , and 512-q may be used for calling a third function (Equation 8) 505 generating Vi that is a virtual i-th shot.

The apparatus for video data augmentation uses the above-described third function 505 to construct the substitute sub videos 520-1, . . . , and 520-1+m corresponding to the shot unit obtained by adding the length m to the deformation start point i starting from the shot of the deformation start point i. The first, second, and third functions used for constructing the substitute sub videos 520-1, . . . , and 520-1+m may be constructed by using recurrent neural networks (RNNs), long short-term memory models (LSTMs), generative adversarial networks (GANs), and the like.

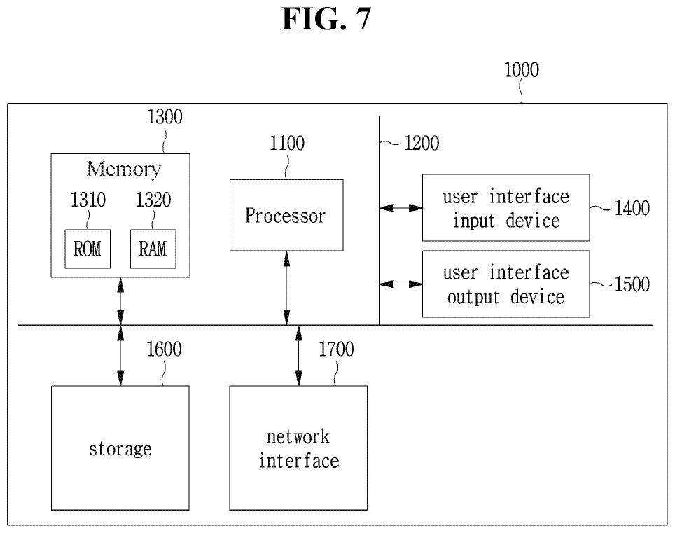

FIG. 7 is a block diagram illustrating a computing system that executes a method and apparatus for video data augmentation according to an embodiment of the present disclosure.

Referring to FIG. 7, a computing system 100 may include at least one processor 1100 connected through a bus 1200, a memory 1300, a user interface input device 1400, a user interface output device 1500, a storage 1600, and a network interface 1700.

The processor 1100 may be a central processing unit or a semiconductor device that processes commands stored in the memory 1300 and/or the storage 1600. The memory 1300 and the storage 1600 may include various volatile or nonvolatile storing media. For example, the memory 1300 may include a ROM (Read Only Memory) and a RAM (Random Access Memory).

Accordingly, the steps of the method or algorithm described in relation to the embodiments of the present disclosure may be directly implemented by a hardware module and a software module, which are operated by the processor 1100, or a combination of the modules. The software module may reside in a storing medium (that is, the memory 1300 and/or the storage 1600) such as a RAM memory, a flash memory, a ROM memory, an EPROM memory, an EEPROM memory, a register, a hard disk, a detachable disk, and a CD-ROM. The exemplary storing media are coupled to the processor 1100 and the processor 1100 can read out information from the storing media and write information on the storing media. Alternatively, the storing media may be integrated with the processor 1100. The processor and storing media may reside in an application specific integrated circuit (ASIC). The ASIC may reside in a user terminal. Alternatively, the processor and storing media may reside as individual components in a user terminal.

The exemplary methods described herein were expressed by a series of operations for clear description, but it does not limit the order of performing the steps, and if necessary, the steps may be performed simultaneously or in different orders. In order to achieve the method of the present disclosure, other steps may be added to the exemplary steps, or the other steps except for some steps may be included, or additional other steps except for some steps may be included.

Various embodiments described herein are provided to not arrange all available combinations, but explain a representative aspect of the present disclosure and the configurations about the embodiments may be applied individually or in combinations of at least two of them.

Further, various embodiments of the present disclosure may be implemented by hardware, firmware, software, or combinations thereof. When hardware is used, the hardware may be implemented by at least one of ASICs (Application Specific Integrated Circuits), DSPs (Digital Signal Processors), DSPDs (Digital Signal Processing Devices), PLDs (Programmable Logic Devices), FPGAs (Field Programmable Gate Arrays), a general processor, a controller, a micro controller, and a micro-processor.

The scope of the present disclosure includes software and device-executable commands (for example, an operating system, applications, firmware, programs) that make the method of the various embodiments of the present disclosure executable on a machine or a computer, and non-transitory computer-readable media that keeps the software or commands and can be executed on a device or a computer.

What is claimed is:

1. An apparatus for augmenting video data, the apparatus comprising:
a feature information check unit checking feature information including a content feature, a flow feature, and a class feature for a sub video of a predetermined unit constituting an original video;
a section check unit selecting a video section including at least one sub video on the basis of the feature information for the sub video; and
a video augmentation unit extracting at least one substitute sub video corresponding to the selected video section from multiple pre-stored sub videos, and applying the extracted at least one sub video to the selected video section to generate an augmented video.

2. The apparatus of claim 1, wherein the section check unit checks a change amount of the at least one sub video on the basis of the class feature, and selects the video section on the basis of the change amount.

3. The apparatus of claim 2, wherein the section check unit checks an average value and a deviation value for the content feature and the flow feature, checks a probability value on the basis of the average value and the deviation value, and selects the video section in consideration of a ratio between the probability value and the change amount.

4. The apparatus of claim 2, wherein the section check unit checks a start point of the at least one sub video on the basis of the class feature, checks the length information from the start point, and selects the video section on the basis of the start point and the length information.

5. The apparatus of claim 1, wherein the video augmentation unit extracts the at least one substitute sub video corresponding to the selected video section in consideration of feature information of the multiple pre-stored sub videos and feature information of a sub video adjacent to the selected video section.

6. The apparatus of claim 1, further comprising:
a video learning unit performing learning using the augmented video.

7. The apparatus of claim 1, wherein the video learning unit checks a class feature and location information of an original video corresponding to the augmented video, and specifies the class feature and the location information of the original video.

8. The apparatus of claim 7, wherein the video learning unit checks a class feature of a sub video unit included in the augmented video, checks reliability of the sub video unit, and specifies the class features and the reliability for the sub video unit.

9. A method for video data augmentation, the method comprising:
checking feature information including a content feature, a flow feature, and a class feature for a sub video of a predetermined unit constituting an original video;
selecting a video section including at least one sub video on the basis of the feature information for the sub video;
extracting at least one substitute sub video corresponding to the selected video section from multiple pre-stored sub videos; and
applying the extracted at least one substitute sub video to the selected video section to generate an augmented video.
